(19) United States
(12) Patent Application Publication
(10) Pub. No.: US 2024/0202698 A1
(43) Pub. Date: Jun. 20, 2024

(54) ELECTRONIC SALES METHOD

(71) Applicant: THOMAS W. HEETER, JACKSONVILLE, FL (US)

(72) Inventor: THOMAS W. HEETER, JACKSONVILLE, FL (US)

(21) Appl. No.: 18/285,826

(22) PCT Filed: Apr. 6, 2022
(86) PCT No.: PCT/US22/23578

§ 371 Date: Oct. 5, 2023

Related U.S. Application Data
(63) Continuation-in-part of application No. 17/223,168, filed on Apr. 6, 2021.

(51) Int. Cl. G06Q 20/32; G06Q 20/10; G06Q 20/20; G06Q 20/38; G06Q 20/40

(52) U.S. Cl. CPC G06Q 20/3276; G06Q 20/1085; G06Q 20/20; G06Q 20/3223; G06Q 20/381; G06Q 20/401; G06Q 2220/00

(57) ABSTRACT

A method is presented for facilitating sales transactions by electronic media. A barcode or other design containing merchant seller information is attached to a decal, label or stamp sheet to enable electronic payment to a merchant seller's account. The decal sheet is made with an adhesive sufficient to allow the decal label once printed, to be attached to a personal object during the period of time for which a financial transaction might occur. The decal label is then removed from the decal label sheet and applied to the personal object provided by the merchant. Before the sales transaction can be consummated, the decal label information is scanned by the buyer's smartphone. Characteristics about the decal label are compared to characteristics about the decal label's information digitally stored on a computer database in question in order to validate the identity of the merchant seller. Once seller merchant's information is validated, the seller may be authorized to debit (or cause a charge) the buyer's electronic account in order to consummate the transaction or transactions. The seller's electronic merchant bank account may be similarly updated.

### TECHNICAL FIELD

The present invention relates to the identification of humans. More particularly, the present invention relates to the use of temporary codes for purposes of identification in order to conduct monetary and credit transactions in a secure manner.

### BACKGROUND ART

The disclosure of my earlier patent, U.S. Pat. No. 5,878,155, issued Mar. 2, 1999 is incorporated herein by reference. In U.S. Pat. No. 5,878,155 at column 2, lines 40-42, the possibility employing temporary tattoos for the verification method disclosed therein is disclosed. The present invention in one embodiment provides a further security improvement by employing a series of temporary tattoos, each valid only for a temporary period of time, or, alternatively, a temporary tattoo or sticker carrying a barcode or the like coupled an identity confirmation step that employs a buyer's cell phone.

Further, the temporal sequence of the tattoos or barcode markings themselves need not follow any logically sequential pattern, and in fact they ideally would not follow recognizable visual sequence so that random guessing of the next tattoo in the sequence would be virtually impossible for an outsider to do.

In my PCT patent application number PCT/US10/02986 filed Nov. 17, 2010, the disclosure of which is incorporated herein, there is disclosed a further security improvement by employing a series of temporary tattoos, each valid only for a temporary period of time, or, alternatively, a temporary tattoo, label, decal or the like carrying a barcode or the like coupled to an identity confirmation step that employs a buyer's cell phone.

Like one of the earliest inventions that combined sand and paper to create “sand-paper”, this invention combines two independent patent application lines flowing from original applications PCT/US2011/02986 and PCT US2011/00855, which now continue as the three co-pending applications noted on page 3 below.

Pending application number U.S. Ser. No. 13/509,041 filed May 10, 2012 titled ELECTRONIC SALES METHOD”, which is a continuation in part of U.S. Ser. No. 12/590,940 the national phase application which claims the benefit of PCT application number PCT/US2011/02986, with a priority date of Nov. 17, 2009, the disclosure of which is incorporated herein by reference.

In application Ser. No. 13/509,041 an authentication method is disclosed that employs temporary tattoos, decals, or labels in a series, which are scanned by a smart-phone to authenticate a person's identity, and wherein a specific embodiment disclosed was for the purpose of making a payment.

Abandoned application U.S. Ser. No. 14/079,402 based on nat'l phase of PCT US2011/00855 was continued prior to abandonment in three currently pending applications: 1. U.S. Ser. No. 15/657,827 file Jul. 24, 2017, 2. U.S. Ser. No. 16/385,650 filed Apr. 16, 2019 and 3. Ser. No. 16/866,132 filed May 4, 2020, which are also incorporated herein by reference.

In application Ser. No. 14/079,402, filed Nov. 13, 2013 and titled “METHODS 10 FOR CONDUCTING ELECTRONIC PAYMENT TRANSACTIONS WITH SCANNABLE CODES”, which claims the benefit of PCT patent application number PCT/US2011/00855 filed May 13, 2011, an authentication method is disclosed wherein a seller merchant provides an image of the bar code at a point of sale for goods or services which is captured by a buyer's smart phone to facilitate a monetary transaction, with the original specification being incorporated by reference in child applications.

### DISCLOSURE OF INVENTION

A method is presented for facilitating sales transactions by electronic media. A barcode or other design containing merchant seller information is attached to a decal, label or stamp sheet to enable electronic payment to a merchant seller's account. The decal sheet is made with an adhesive sufficient to allow the decal label once printed, to be attached to a personal object during the period of time for which a financial transaction might occur. The decal label is then removed from the decal label sheet and applied to the personal object provided by the merchant. Before the sales transaction can be consummated, the decal label information is scanned by the buyer's smartphone. Characteristics about the decal label are compared to characteristics about the decal label's information digitally stored on a computer database in question in order to validate the identity of the merchant seller. Once seller merchant's information is validated, the seller may be authorized to debit (or cause a charge) the buyer's electronic account in order to consummate the transaction or transactions. The seller's electronic merchant bank account may be similarly updated.

### BRIEF DESCRIPTION OF DRAWINGS

FIG. 1 is a pictorial illustration of a calendar page embodying certain features of an embodiment of the invention.

FIG. 2 is a pictorial illustration of a card embodying certain features of an embodiment of the invention.

FIG. 3 is a pictorial illustration showing a temporary tattoo being applied to a user in accordance with an embodiment of the invention.

FIG. 4 is a pictorial illustration showing a temporary tattoo being scanned while on a user in accordance with an embodiment of the invention.

FIG. 5 illustrates a “One Card” in accordance with an embodiment of the invention.

FIG. 6 illustrates by box diagram the communication nodes and pathways employed in an embodiment of the invention.

FIG. 7 illustrates schematically the transmissions of electronic information in accordance with an embodiment of the invention.

FIG. 8 illustrates a scannable image, comprised of an original image with pixels altered in such a way that scanning the image yields a data string.

FIG. 9 is a flowchart illustrating a first embodiment of the invention.

FIG. 10 is a flowchart illustrating a second embodiment of the invention.

FIG. 11 is a flowchart illustrating another way of carrying out the second embodiment of the invention.

FIG. 12 is a flowchart is a flowchart illustrating a third embodiment of the invention.

FIG. 13 is a flowchart illustrating further aspects of the third embodiment of the invention.

FIG. 14 is a flowchart illustrating further aspects of the first embodiment of the invention.

FIG. 15 is a flowchart illustrating further logic for the FIG. 6 flowchart.

FIGS. 16A and 16B depicts the most basic level functional step of a preferred embodiment of the invention such that the payment card displays a scannable code when the privacy slide is opened when the payment card is inserted into a payment terminal, with the scannable code being linked to the card holder user's identity data.

FIG. 17 depicts an example of a payment processing machine with an optically scannable payment card inserted.

FIG. 18 depicts the preferred embodiment where the radio transceiving payment card is electronically connected to the card holder user's mobile device which provides a temporary user interface while the card is inserted into the payment processing machine, being simultaneously connected to the card holder user's mobile device and the payment processing machine, while the electronic payment is being conducted.

FIG. 19 depicts the card holder user's mobile device.

FIG. 20 depicts an embodiment of the invention showing insertion of a card with micro-USB dongle into a mobile device in isometric view.

FIG. 21 depicts the embodiment shown in FIG. 12 after insertion.

FIG. 22 depicts a sheet of peel-off stickers that encode seller information for receiving payment.

FIG. 23 depicts a item for sale that displays the seller information on a sticker or by direct printing.

FIG. 24 depicts a smart watch that displays an image of the sticker for scanning by a smart phone.

FIG. 25 depicts a coin counting machine that can be used in an embodiment of the invention.

FIG. 26 depicts a money order issuing from the coin counting machine according to an embodiment of the invention.

### BEST MODE FOR CARRYING OUT THE INVENTION

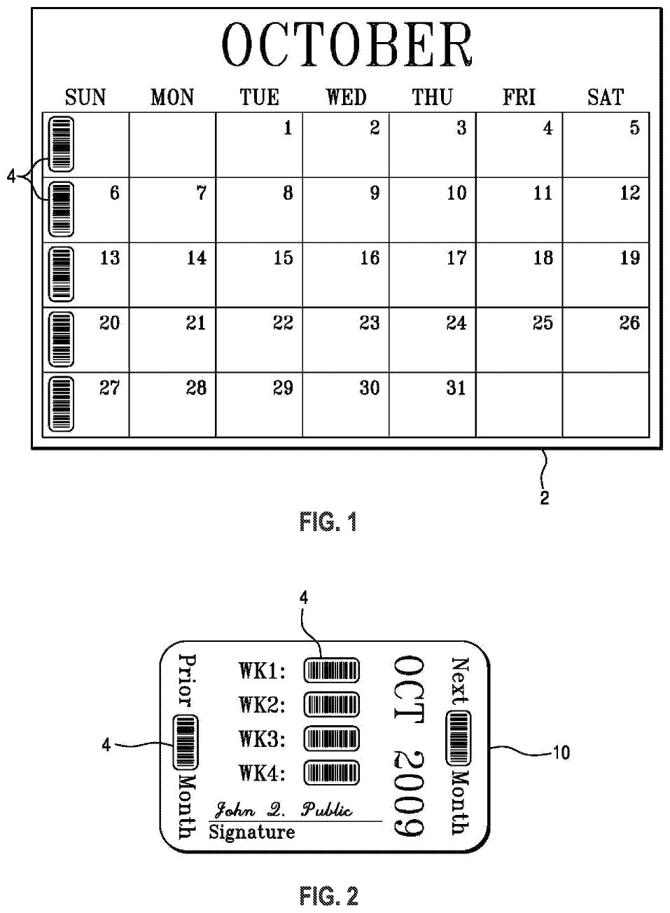

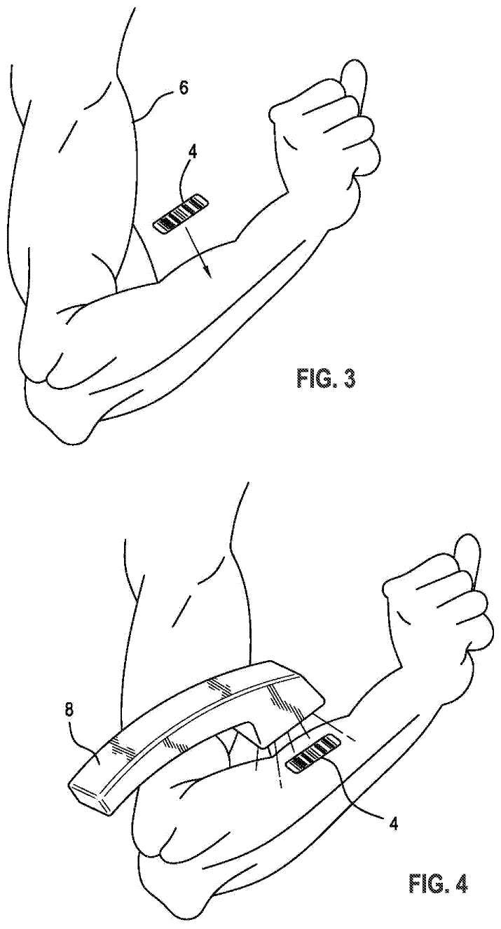

### Ser. No. 13/509,041 (FIGS. 1-8)

In accordance with one embodiment of the invention, there is provided a method of human identification. The method is carried out by providing identity information for a human in an electronic database, and providing identity information for a plurality of marks in an electronic database, each mark being associated with the identity information for the human in a validating way only for a predetermined time period. The human is then provided with a means for transferring marks which convey the mark identity information to a scanner onto their person or a personal object for use during the predetermined time period. Identification is established or, or more preferably, confirmed, by scanning a mark from a person or personal object, and determining electronically from the databases whether the scanned mark is valid.

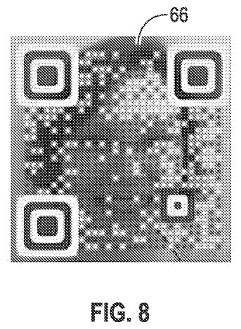

Preferably, the scanned mark is signaled valid only if it is associated with the identity information for the human and is scanned during the predetermined time period. In a preferred embodiment, each mark is validly associated with the human identity information for only one of a plurality of predetermined chronological time periods, one mark for each time period, and the time periods are sequential. To provide for correspondence with the database on the user end, the user is provided with means for sequential transfer of a mark for each of the predetermined time periods. For example, the human user can be provided with electronic files for printing the marks on temporary tattoo sheets. The files can be transmitted over the internet, for example, or mailed in hard form. Alternatively, the human can be provided with temporary tattoo sheets carrying the marks in transferrable form thereon. The mark can be in any form that provides an easily changeable data string. For example, a barcode or other scannable design that yields a data string can be employed, as depicted in FIG. 8. Mixtures of dyes fluorescing (or absorbing) at different wavelengths could also be used to form binary codes readable with an appropriate scanner independently of the shape of the mark.

In response to a determination that the scanned mark is valid, a financial transaction for the human can be approved, and a financial account for the human can be debited in the amount of the transaction. As an extra layer of security, which can be triggered in the event that the transaction exceeds a predetermined amount, the identity of the human can be sent from the database to the point of scan for confirmation of identity, by photo-ID for example, or simply a digital image of the presumptive user of the system.

In another embodiment of the invention, identity information about a purchaser and corresponding temporal information about a tattoo or other mark is provided on a storage medium. Temporally arranged adhesive transparency sheets, to allow the printing of the tattoos or designs on the adhesive sheets, are also provided. The sheets are organized in such a way that they can be temporally verified, for example, in calendar form. Marking ink for applying to the adhesive sheets to form tattoos or designs is also provided. The marking ink is applied to the sheets to form the tattoos. Characteristics about the tattoos and corresponding temporal information during which the tattoos are considered valid are stored electronically on storage medium and linked to the identity information about the purchaser to validate use of the tattoos for purchases. Identity confirmation can be provided by transmitting back to the scan point and displaying the name associated in the database with the temporal mark.

Certain embodiments of the invention make use of two-dimensional data matrix codes. These can be utilized in the form of temporary tattoos, or in the form of decals stamps or stickers that can be affixed to a plastic card or other personal object and used to replace debit or credit cards.

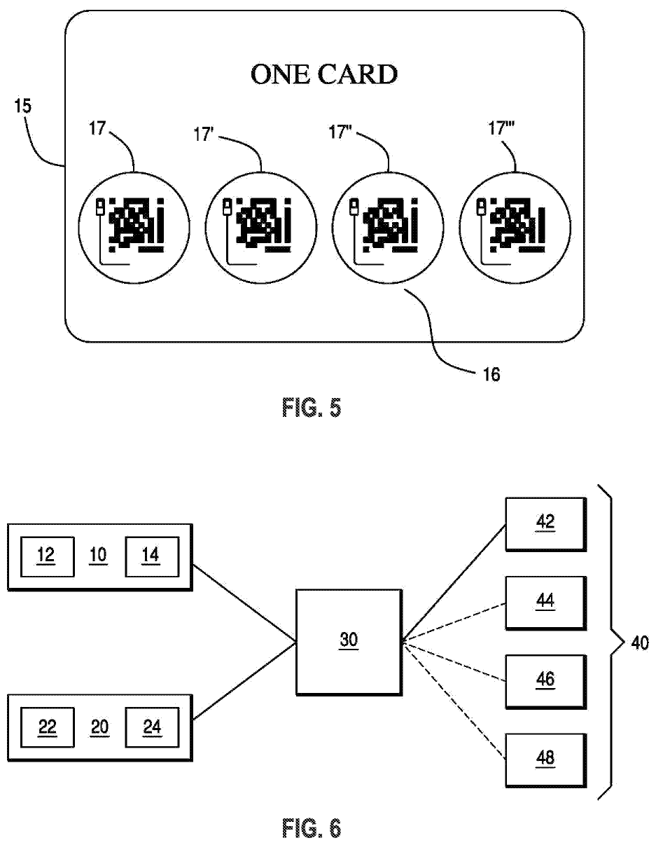

In one embodiment of the invention as shown in FIG. 5, there is provided a multiple payment option charge card 15 comprising a rectangular card carrying a multiplicity of differing two-dimensional data matrix codes 16 in the form of decals, stamps or stickers 17, 17′, 17″ and 17′″, each data matrix code encrypting a buyer's charge card information, the charge card information being different for each code carried by the card. In this embodiment, the one card replaces several, and is referred to hereinafter as a “One Card”. Preferably, the decals, stamps or stickers are affixed to the One Card with an adhesive system which permits the decal, stamp or sticker to be peeled intactly from the card without the use of tools. This permits the information to be easily replaced, to reduce the risk of compromise. Generally, the data matrix codes are embodied in a square pattern measuring in the range of from 1 to 30 mm on a side and further encode contact information to enable communication between a seller's scanner and a remote location.

The customer could sign up online, or be part of a targeted mailout, or they could be “auto enrolled” when they receive a payment from an existing Paypal or other electronic payment systems company customer if certain criteria are met. Traditional customers would receive their One Card packages in the mail, in the form of a One Card and a sheet of green PayPal (or equivalent) stickers, each bearing a unique data encryption, plus collateral materials such as instructions.

The customer then can proceed in one of several ways. Option 1 is to text number and receive a URL line to cell phone to download software, which includes an integrated point of sale terminal. Option 2 is for the customer to call a phone number, enter their cell phone number, and receive a URL link text to download scanner software, which includes an integrated point of sale terminal. Option 3 is for the customer to go online to an electronic payment systems company site, such as the PayPal site, download the software, and enroll at the PayPal site. Option 4 is to receive a link to sign up at click thru links from, say Facebook. Another option would be to receive the two-dimensional data matrix codes via a web sign up. The customer could then download and print their own labels.

It is expected that the smartphone itself would manage security by keeping track of location, for example, so that transactions from unusual locations could be flagged for greater scrutiny during the approval process. Another security layer could be provided by instructions to accept transactions only from a certain MAC address, or group of addresses, to limit use of the sticker to a single smartphone, or group of smartphones.

To register a two dimensional data matrix code for use, the customer would digitally photograph or scan the decal, etc. and transmit the image to the remote processing location. The user would then be prompted to associate the image with desired credit card particulars, including name of card, name of user, credit card number, expiration date, and csv number. The decal could then be affixed to a blank carrier, as in FIG. 5, their driver's license or other identity card, or attached to the corresponding credit card or a rewards card.

One embodiment illustrating use of the One Card system is illustrated in FIG. 6. A seller 10 is provided with a smartphone 12 and a decal, stamp, sticker or like 14 embodying a barcode such as a two dimensional data matrix code. A buyer 20 wishing to conduct a sales transaction with the seller is provided with a smartphone 22 and a decal, stamp, sticker or like 24 embodying a barcode such as a two dimensional data matrix code. Both the seller and the buyer are connectable to a remote location 30 which provides transaction control via communication pathways provided by smartphone system coverage, for example. The remote location is connectable via secure communication pathways to credit and/or debit card payment centers 40, for example, Visa payment center 44, MasterCard payment center 46, or Discover payment center 48, or an electronic payment systems company 42, for example, PayPal, which can effect indirect communication between the seller and the payment center.

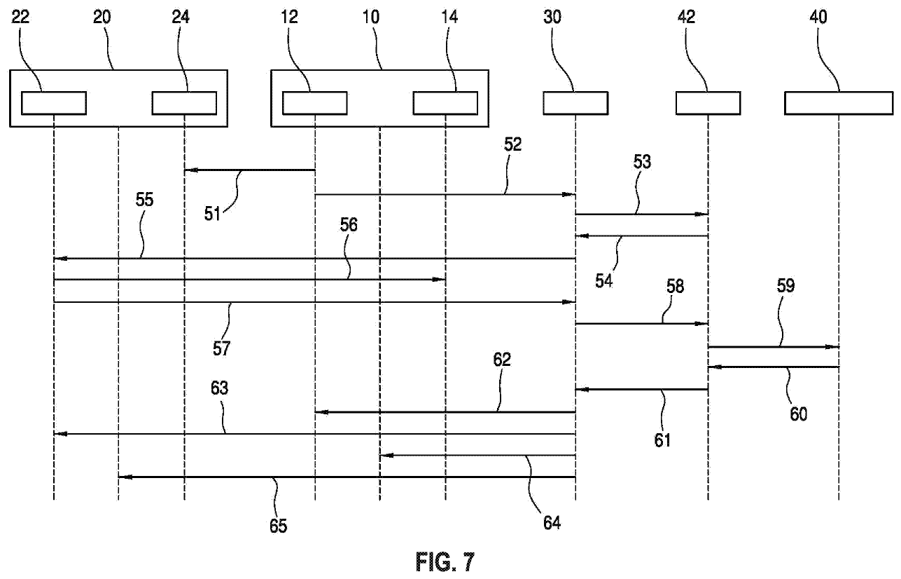

FIG. 7 schematically illustrates a method for completing a sales transaction between a buyer 20 having a smartphone 22 and a seller 10 optionally having a smartphone 12. The buyer's smartphone has a digital camera function, an interactive display, and is provided with applications software to enable steps of the method which are carried out at the buyer's smartphone.

According to the method an amount to be charged for the sales transaction is established. Usually, it is the seller who establishes this, for example, by scanning the items to be sold. The seller then optically captures buyer data code from the buyer at 54. Preferably, this is done by scanning the buyers decal 24 which encodes the data. The buyer data code and the amount to be charged are then transmitted over a communication pathway, for example, at 25 to a remote location 30, such as over a cell phone grid. The location 30 provides necessary computer and software support to control the sales transaction.

At the remote location, the buyer data is associated with contact information for the buyer in an electronic database. The contact information includes the buyer's smartphone number. Information representative of the amount to be charged is transmitted to the buyer's smartphone display at 55.

The buyer captures the seller's data from the seller with the buyer's smartphone camera function. Preferably, this is accomplished by the buyer scanning the seller's decal 14 at 56. The buyer also inputs payment data using the buyer's smartphone display function, for example, a credit card selected for payment, and transmits from the buyer's smartphone, at 57, the seller data together with the payment data information to the remote location.

The remote location transmits at 58 a payment request from the remote location to a payment center 42 and receives back an approval (or declination) at 61. The approval or declination is transmitted to the buyer's smartphone at 63 and to the seller at 62.

Preferably, the buyer data is embodied in a two-dimensional data matrix code and the two dimensional data matrix code is embodied in a square pattern and is printed on thin substrate selected from a decal, stamp or sticker. The thin substate is preferably carried on a plastic card or other object, preferably an object other than the buyer's smartphone.

The step of optically capturing buyer data from the buyer is preferably carried out by the seller after activating a software application for enabling the method steps carried out by the seller. Prior to the step of the buyer inputting the buyer's payment data, the method preferably comprises electronically fetching predetermined payment option data for the buyer at 53 and transmitting the payment option data to the buyer's smartphone display as at 54. The payment option information can be obtained from a remote information repository for such information maintained by a electronic payment systems company 42 such as PayPal. The payment options are preferably displayed on the buyer's smartphone display function and the buyer indicates their selection using the touchscreen functionality of the smartphone.

Preferably, the seller data, also, is embodied in a two dimensional data matrix code and the smartphone decodes the matrix to obtain the seller data transmitted together with the payment data. This information is preferably received at the payment center 42 which requests authorization for payment at 59 from a credit card center 40 and receives back an authorization (or declination) at 60.

If desired, receipts for the transaction can be transmitted from the remote site to the seller at 64 and to the buyer at 65.

One embodiment of the invention is further illustrated by the following example.

### EXAMPLE

Suppose a traveler wants to go on a cruise. They receive a calendar page 2 from their bank (or any other financial institution that facilitates electronic transactions) that has pre-printed temporary tattoos 4, say, as part of a calendar. See FIG. 1. These could either be based on the customer's selection, or, alternatively, the customer could develop their own tattoo designs at home and then submit their own design(s) to the bank to be included in the preprinted calendar.

The traveler simply peels the given tattoo off for the preselected days for which he or she will be using it, and then puts the tattoo on a scannable part of their body, for example, their arm 6, or on a card, for example, a photo-ID such as their driver's license, or their passport. Suppose the traveler has selected “weekly” security. In that case, they would change tattoos (and thereby security codes, or access codes) once per week according to a predetermined schedule. The traveler then logs into a terminal to book the reservation either from home or in the offices of a travel agent.

The computer scan verifies that the tattoo code is for that person, and that it is being used during an authorized time period. Once the data has been verified, they make the purchase and have their preferences, such as meal preferences, registered based on the tattoo. The temporal tattoo system provides more security than credit cards because the information is changed with a relatively high degree of frequency at a very minimal cost as compared to issuing a new credit card. Typically, new credit cards are issued at intervals from one to three years for a given customer unless the customer reports some kind of irregularity for which the customer has the burden to discover and report.

To make a purchase, the user has the mark scanned by scanner 8 and the information is transmitted to a database for confirmations and approval. If desired, a series of tattoo codes could be provided on a credit card sized (about 85×54 mm) card 10 which could be transferred to the user or read directly from the card.

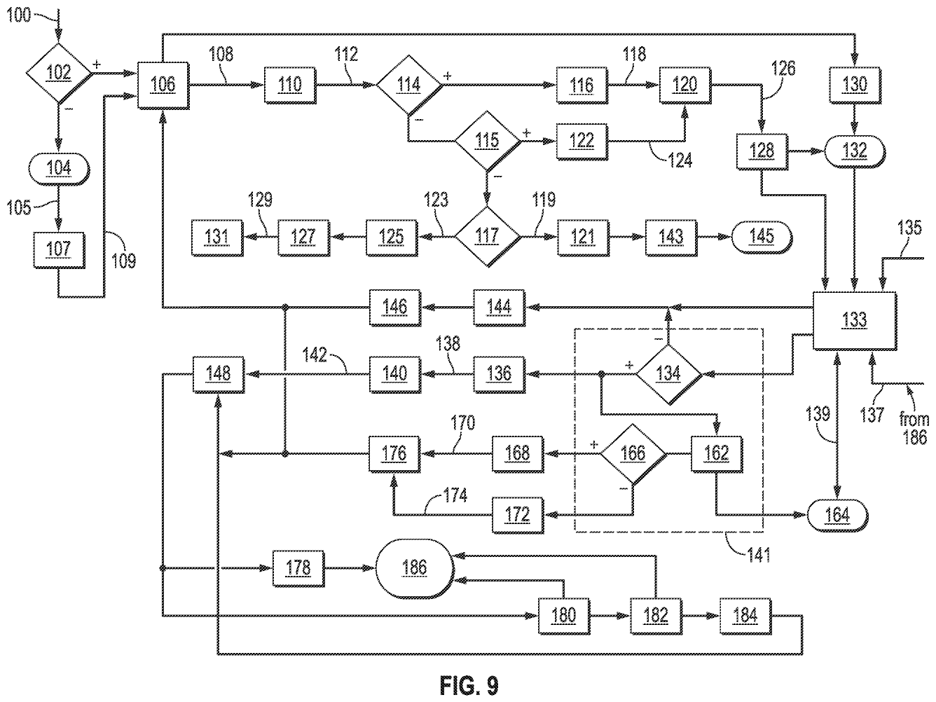

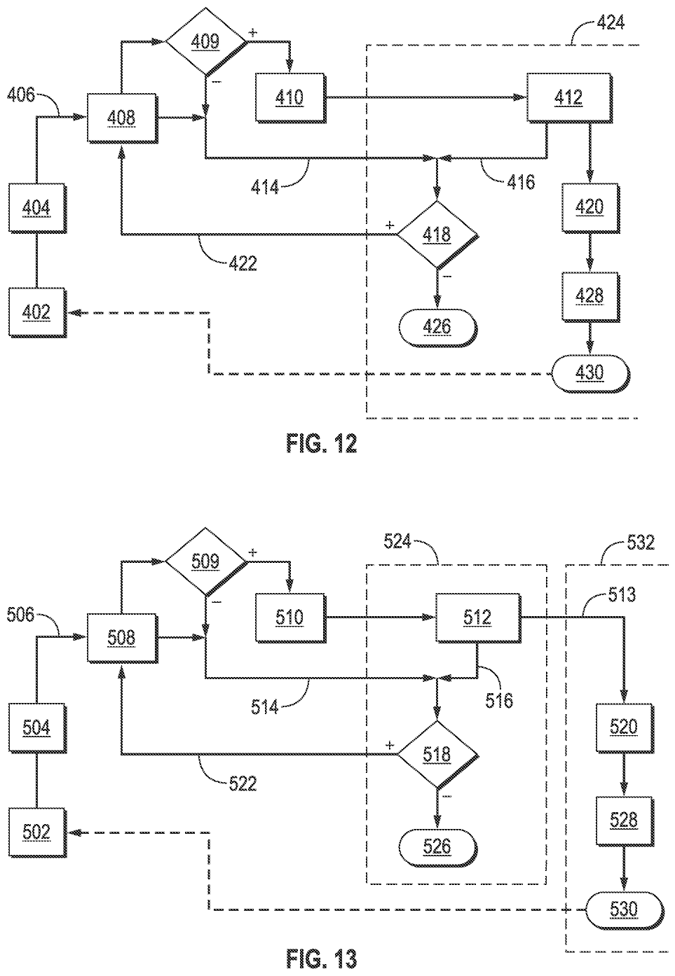

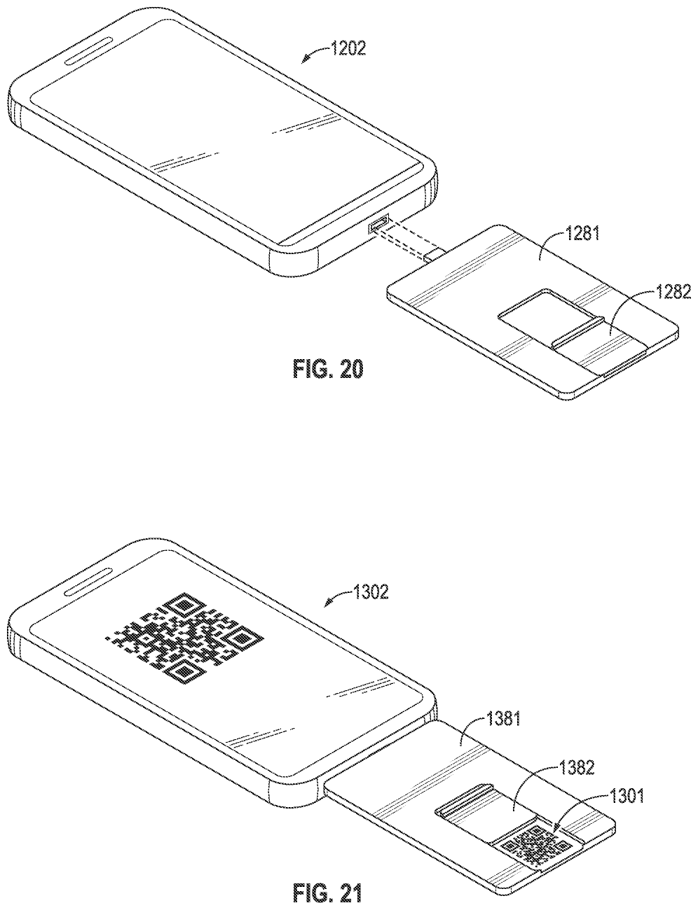

### Best Mode for Carrying out the Invention Ser. No. 16/866,132 (FIGS. 9-21)

The first embodiment of the invention employs a seller bar code encoding information electronically linkable to a seller's account, the seller's account belonging to an intended recipient of the electronic payment. A smart-phone with a camera function is employed for capturing an image of the seller bar code, or reading it. A wireless communication system is employed for transmitting data, including data representative of the seller bar code image, from the camera to a remote payment center. Computer applications are present on the smart-phone and at the remote payment center to enable data transmission over the wireless communication system and to authorize the payment center to transfer funds from a buyer's account, typically belonging to the smart-phone owner, to the seller's account. The method is carried out by providing an image of the bar code at a point of sale for goods or services, capturing an image of the bar code, or reading it, with the camera function of the smart phone, processing the image with the smart-phone application to form a wirelessly transmittable data file, wirelessly transmitting the data file from the smart-phone to the payment center, wirelessly transmitting a data file representative of a payment amount from the smart-phone to the data center, electronically debiting the buyer's account by the payment amount, electronically crediting the seller's account by the payment amount, and transmitting data representative of the crediting of the seller's account to the seller.

The bar code is preferably a two-dimensional bar code. The bar code can further encode a telephone number for establishing contact with the payment center, which the smart phone application reads and dials, or other seller information. The user of the smart-phone can enter, using their keypad, a payment amount which is transmitted to the payment center, and notification of payment can be sent from the payment center to the seller's device at the point of sale. The bar code can be printed on a sign, or it can be electronically generated and displayed on a viewer. Where the code is electronically generated, it can further encode the amount due, which the application on the seller's phone reads and displays, for example, for confirmation by the buyer.

As an example of the first embodiment of the invention, suppose the merchant says the customer owes $25.00. The customer enters $25.00 into their smartphone, scans the merchant's label, and commands send, which (through an application residing in the smartphone), transmits the payment authorization to the payment center, where, contingent on acceptance by the payment center and optionally the merchant, the account associated with the smartphone is debited $25.00 and the account associated with the label is credited $25.00. Notification of the crediting of the merchant account is transmitted to the pay point associated with the merchant's label, where the merchant (and/or customer) can optionally be required to accept the payment, the acceptance being transmitted back to the payment center for the storing of an electronic record of the transaction.

The method takes care of paying the merchant without transmitting customer account information over the airwaves. The merchant account can be made secure by being only configured to accept payments.

The second embodiment of the invention makes use of a randomly generated code. An application and a first hardware set is employed to generate the code and display a two-dimensional barcode image representative of the code. Additional nonrandom information may be encoded as well. An application and a second hardware set including a camera function is employed for capturing or reading the displayed barcode image from the first hardware set. Both hardware sets then transmit data strings representative of the barcode image to a remote payment center. At least one of the data strings further includes payment amount data. An application on a third hardware set at the payment center is provided for associating the first data string and the second data string with each other and authorizing an electronic transfer of funds in the amount of payment between an account associated with the first hardware set and an account associated with the second hardware set. The method is carried out by generating and displaying the barcode image on the first hardware set and transmitting a first data string to the remote payment center. The displayed barcode image is captured or read by the second hardware set and the second data string is transmitted to the remote payment center. A data string representative of the amount of payment is also transmitted to the remote payment center. At the remote payment center, the first data string is associated with the second data string and the amount of payment, and the electronic transfer of funds in the amount of payment between the account associated with the first hardware set and the account associated with the second hardware set is authorized.

The barcode can be generated by either the seller's or the buyer's equipment. Thus, either or both of the first hardware set and the second hardware set can comprise a smartphone. The data string representative of the amount of payment can be transmitted to the remote payment center by either one of the first hardware set and the second hardware set, and the remote payment center can forward the data string representative of the amount of payment to the other of the first hardware set and the second hardware set for confirmation, and the hardware set which receives the forwarded data string can transmit a data string back to the payment center representative of acceptance of the amount.

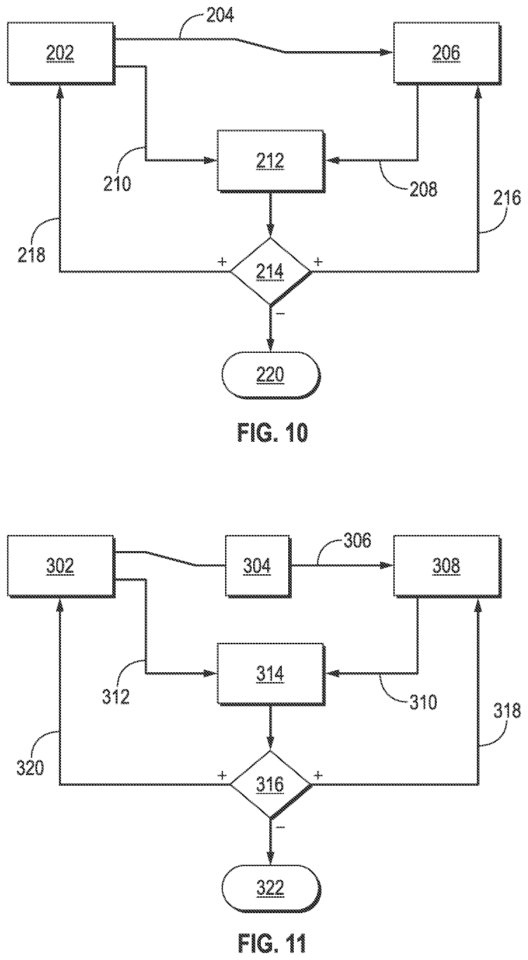

In a preferred embodiment of the second embodiment of the invention, as illustrated in FIG. 10, the customer's phone dynamically generates a unique 2D Bar Code for transaction and a micromerchant's phone takes a photograph of the 2D bar code image or otherwise decodes the embedded code. After validation, the Payment Center sends a unique generated code for the transaction to both customer and merchant. Alternatively, the second embodiment can be carried out as shown in FIG. 11, where the merchant's phone dynamically generates a unique 2D bar code for the transaction, the customer phone takes a picture (static image) of the 2D barcode or decodes the embedded code, and the payment center receives (along with transaction data) the unique 2D bar code or embedded code.

As an example of a second embodiment of the invention, a customer wanting to pay a merchant commands the production, via an application residing in their smartphone, of a data matrix code image on the viewer of their smartphone. The data matrix code is single-use, at least a portion of the code being randomly generated by the customer's smartphone. The merchant scans the customer's data matrix code image and transmits, via an application residing the merchant hardware, the data matrix code image, the amount of the transaction, and merchant information to the payment center associated with the data matrix code image. The buyer transmits the data matrix code to the payment center, where it is matched up to the merchant transmission, and contingent on the data matrix image being unique, associated with the buyer's account for debiting and the merchant's account for crediting in the amount of the transaction. Notification of the crediting of the merchant account (or rejection of the code) is transmitted to the paypoint associated with the merchant's transmission, and the merchant (and/or customer) can optionally be required, if the transaction is to proceed, to accept the payment, the acceptance being transmitted back to the payment center for the storing of an electronic record of the transaction. Alternatively, the transaction can begin by the merchant generating the data matrix code image containing a portion which is randomly generated and the buyer captures an image of the merchant's code for transmission to the payment center. The transaction then proceeds, mutatis mutandis, through the crediting notification/confirmation steps as above.

In the second embodiment of the invention, the customer's account is protected against unauthorized debiting by a single-use lengthy random code string which must be matched and preferably corroborated in some way in order for the debit to proceed.

The third embodiment of the invention is described as a method for password-protecting a smart-phone application where the smart-phone has a camera function. The method is carried by providing a user of the smart phone with an inked two-dimensional barcode mark, and providing selected of the user's smart-phone applications with an unlock application functionally dependent on scanning or capturing an image of the inked two-dimensional barcode mark. The method is carried out by scanning or capturing an image of the inked barcode with the camera function of the smart-phone, and processing the image with the unlock application to access the selected application.

The smartphone application can be configured to time-out the period during which it will accept a given code. In such case the scanned mark unlocks the application only if the mark is scanned during a predetermined time period. The user would have to change the bar code and reset the application periodically in order to maintain functionality and avoid being locked out of applications on their own phone. The inked two-dimensional bar code could be printed on the skin of the user or on a sticker or label applied to a personal object of the user. One application that would be especially desirable to password protect in the manner of the third embodiment of the invention would be where the smartphone user is attempting to make an electronic payment over a predetermined amount, say over $100. In that case, the financial account of the user would be debited in the amount of the electronic payment only after the printed barcode was scanned.

As an example of a third embodiment of the invention, a smartphone user also carries an image of a data matrix code. The code can be in the form of a sticker that is carried on a card, for example. The user's smartphone is provided with an application that only permits certain applications on the smartphone to be used after the data matrix code is scanned. The application can be used to lock up payment applications, or used to confirmed payments of over a threshold amount.

The Figures show data flow and logic which can be used to carry out preferred embodiments of the invention. Reference numerals used in the Figures are as follows:

| | |
|---|---|
| 100 | Do you have SmartPay? |
| 102 | Customer has Smartpay? |
| 104 | Dial or Text number of Server to Customer phone |
| 105 | Customer requests Smartpay Appl by phone |
| 106 | Customer (Payment Sender) |
| 107 | Telephony server |
| 108 | Amount |
| 109 | Smartphone application downloaded to Customer phone |
| 110 | Mobile Application entering amount |
| 112 | Amount |
| 114 | Has decal to scan? |
| 115 | Receiver has account? |
| 116 | Mobile Application Scanning Decal |
| 117 | Is Receiver Merchant or other consumer? |
| 118 | Decal Information |
| 119 | Merchant |
| 120 | Mobile Application Sending payment information to Payment |
| | Center |
| 121 | Send link to Web portal |
| 122 | Entering in Receiver's phone # |
| 123 | Consumer |
| 124 | Mobile phone # |
| 125 | Send download link |
| 126 | Payment information (first name, email, phone #, merchant |
| | phone #, trxn # or other info) |
| 127 | Telephony server sends Link |
| 128 | Payment Server Checking customer eligibility (e.g. funds) |
| 129 | SMS link sent to smartphone |
| 130 | Mobile Application Payment Server Creating new Smartpay |
| | customer account |
| 131 | Customer smartphone |
| 132 | SmartPay Customer Account |
| 133 | Payment Server |
| 134 | Is customer eligible? |
| 135 | Customer Data |
| 136 | Payment Server sending approval to customer via email and/or |
| | SMS Messaging |
| 137 | Merchant account data from 186 |
| 138 | Payment Info |
| 139 | Paypal or comparable payment gateway may serve as payment |
| | server |
| 140 | Mobile Application showing transaction approval (also sent to |
| | merchant) |
| 141 | Inside payment server |
| 142 | Payment information |
| 143 | Merchant's desktop, notebook, slate or tablet PC |
| 144 | Payment Server Sending Error message to customer via Mobile |
| | App |
| 145 | Merchant signup |
| 146 | Mobile Application Showing transaction failure to customer |
| 148 | Merchant (Payment Receiver) |
| 162 | Payment Server completes transaction via Paypal or comparable |
| | payment gateway |
| 164 | Paypal or other comparable payment gateway |
| 166 | Did payment gateway successfully fund transaction? |
| 168 | Payment server Sending confirmation to customer and Merchant |
| | via Text and Email |
| 170 | Confirmation |
| 172 | Payment Server Sending Transaction failure information to |
| | Customer and Merchant |
| 174 | Failure information via text and email |
| 176 | Mobile App Showing/Notifying Transaction confirmation or |
| | Failure |
| 178 | Mobile App/Payment Server Creating Smartpay Merchant |
| | Account |
| 180 | Payment Server Logging into SmartPay Merchant Account |
| 182 | Payment Server Generating Decal with Merchant information |
| 184 | Payment Server Printing Decal |
| 186 | SmartPay Merchant Account |
| 202 | Customer's Phone (internally generates dynamic photo code |
| | image) |
| 204 | click (micro)merchant captures image |
| 206 | (Micro)merchant phone |
| 208 | (Micro)merchant phone sends static image (or decodes and sends |
| | unique value) to |
| 210 | Customer phone sends static image to (or decodes and send |
| | unique value) to |
| 212 | Payment Center |
| 214 | Equal? |
| 216 | If yes, payment center sends confirmation code or unique value |
| | to merchant and customer |
| 218 | Generated Confirmation Code |
| 220 | Reject transaction |
| 302 | Merchant's phone (internally generates dynamic photo code |
| | image) |
| 304 | Display 2D image by merchant |
| 306 | click--customer phone captures merchant image |
| 308 | Customer phone |
| 310 | Customer phone sends static image (or decodes and sends unique |
| | value to) |
| 312 | Merchant's phone sends static image (or decodes and sends |
| | unique value to) |
| 314 | Payment center |
| 316 | Static image or digital code embedded processing |
| 318 | Confirmation code to customer |
| 320 | Confirmation code to merchant |
| 322 | Reject transaction |
| 402 | wallet card |
| 404 | scan |
| 406 | digitize |
| 408 | Customer phone |
| 409 | Generate new code? |
| 410 | Customer regenerates new code |
| 412 | Smart Lock database stores code |
| 414 | input (2D code) |
| 416 | Read stored 2D code value from 412 |
| 418 | Equal? |
| 420 | Printer |
| 422 | Unlock phone |
| 424 | Server |
| 426 | Keep locked |
| 428 | Sticker for Wallet card |
| 430 | transmit to customer |
| 502 | Wallet card |
| 504 | Scan |
| 506 | Digitize |
| 508 | Customer Phone |
| 509 | Generate new code |
| 510 | Customer's phone generates new code |
| 512 | Customer's phone internally stores generated code |
| 513 | to printer or external center |
| 514 | Input 2D bar code |
| 516 | Read stored 2D bar code value from 512 |
| 518 | Equal? |
| 520 | printer |
| 522 | Unlock phone |
| 524 | Inside phone (Steps 516-526) |
| 526 | Keep locked |
| 528 | Sticker for wallet card |
| 530 | Print out locally or Transmit to Customer from Processing Center |
| 532 | External printer or processing Center |
| 600 | Do you have SmartPay? |
| 602 | Customer has Smartpay? |
| 604 | Dial or Text number of Server to Customer phone |
| 605 | Customer requests Smartpay Appl by phone |
| 606 | Customer (Payment Sender) |
| 607 | Telephony server |
| 608 | Amount |
| 609 | Smartphone application downloaded to Customer phone |
| 610 | Mobile Application entering amount |
| 612 | Amount |
| 614 | Receiver has decal to scan |
| 615 | Receiver has account? |
| 616 | Mobile Application Scanning Decal |
| 617 | Is Receiver Merchant or other consumer? |
| 618 | Decal Information |
| 619 | Merchant |
| 620 | Mobile Application Sending payment information to Payment |
| | Center |
| 621 | Send link to Web portal |
| 622 | Entering in receiver's phone # |
| 623 | Consumer |
| 624 | Mobile phone # |
| 625 | Send download link |
| 626 | Payment info. (first name, email, phone #, amt, merchant phone |
| | #, trxn# or other info) |
| 627 | Telephony server sends Link |
| 628 | Payment Server Checking customer eligibility (e.g. funds, name, |
| | etc) |
| 629 | SMS link sent to smartphone |
| 630 | Mobile Application Payment Server Creating new Smartpay |
| | customer account |
| 631 | Customer smartphone |
| 632 | SmartPay Customer Account |
| 633 | Payment server |
| 634 | Is customer eligible? |
| 635 | Customer Data |
| 636 | Payment Server sending approval to customer via email and/or |
| | SMS Messaging |
| 637 | Merchant account data from 686 |
| 638 | Payment Info |
| 639 | Paypal or comparable payment gateway may serve as payment |
| | server |
| 640 | Mobile Application showing transaction approval (also sent to |
| | merchant) |
| 641 | Inside payment server |
| 642 | Payment information |
| 643 | Merchant's desktop, notebook, slate or tablet PC |
| 644 | Payment Server Sending Error message to customer via Mobile |
| | App |
| 645 | Merchant signup |
| 646 | Mobile Application Showing transaction failure to customer |
| 648 | Merchant (Payment Receiver) |
| 650 | Mobile Application Receiving Merchant's request for funds |
| 652 | Authorize Response |
| 654 | Mobile Application Sending Merchant's request for funds |
| 656 | Authorize Response |
| 658 | Is transfer authorized? |
| 660 | Payment server evaluates request |
| 662 | Payment Server completes transaction via Paypal (or comparable |
| | gateway) |
| 664 | Paypal or comparable payment gateway |
| 666 | Did payment gateway successfully fund transaction? |
| 668 | Payment server Sending confirmation to customer and Merchant |
| | via Text and Email |
| 670 | Confirmation |
| 672 | Payment Server Sending Transaction failure information to |
| | Customer and Merchant |
| 674 | Failure information via text and email |
| 676 | Mobile App Showing/Notifying Transaction confirmation or |
| | Failure |
| 678 | Mobile App/Payment Server Creating Smartpay Merchant |
| | Account |
| 680 | Payment Server Logging into SmartPay Merchant Account |
| 682 | Payment Server Generating Decal with Merchant information |
| 684 | Payment Server Printing Decal |
| 686 | SmartPay Merchant Account |
| 702 | Customer Smart Phone |
| 704 | Display request for payment from merchant |
| 706 | Customer selects funding source or exit |
| 707 | Exit |
| 708 | Customer selects debit, credit, or paypal |
| 710 | Customer selects Continue |
| 712 | Customer selects Rewards Card |
| 714 | Confirms amount? |
| 716 | Re-enter or Exit |
| 718 | Cash Back? |
| 720 | Process cash back if approved (amount entered, confirmation of |
| | receipt, inform clerk) |
| 722 | To payment server |
| 724 | Query change to charity |
| 726 | If approved, process charity request ($1.00 less decimal part of |
| | bill) |
| 728 | To payment server |
| 730 | Mobile application scans decal |
| 732 | Decal information is transmitted |
| 734 | To payment server |
| 736 | Confirmation to merchant with cash back amount |
| 740 | Customer is given cash back |
| 746 | Print receipt? |
| 748 | Printer |
| 750 | Query whether Seller to be added to contact list |
| 752 | Seller added to contact database |
| 754 | Exit |

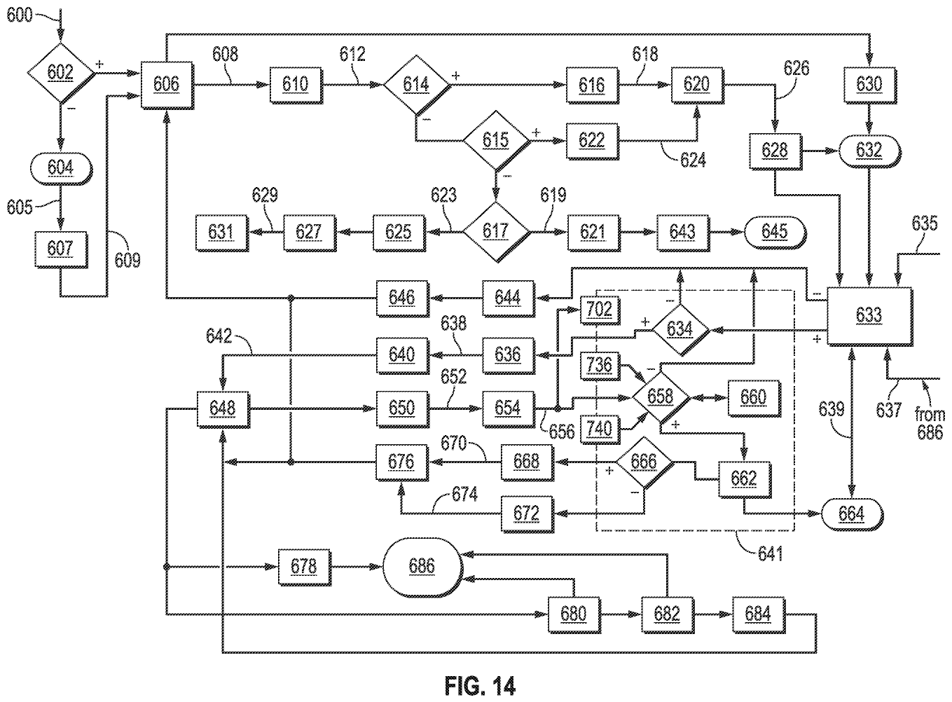

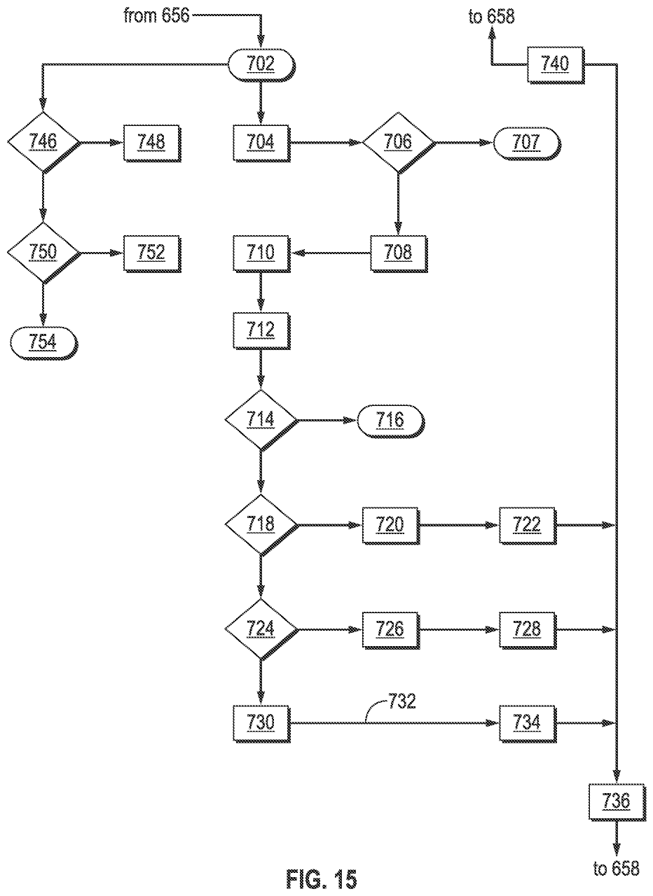

FIGS. 14 and 15 are connected in that the merchant initiates the request for payment 650-656, which then goes to 702, and after the user/consumer has made choices, the flow goes back to the Payment Server to authorize the transfer (658-660).

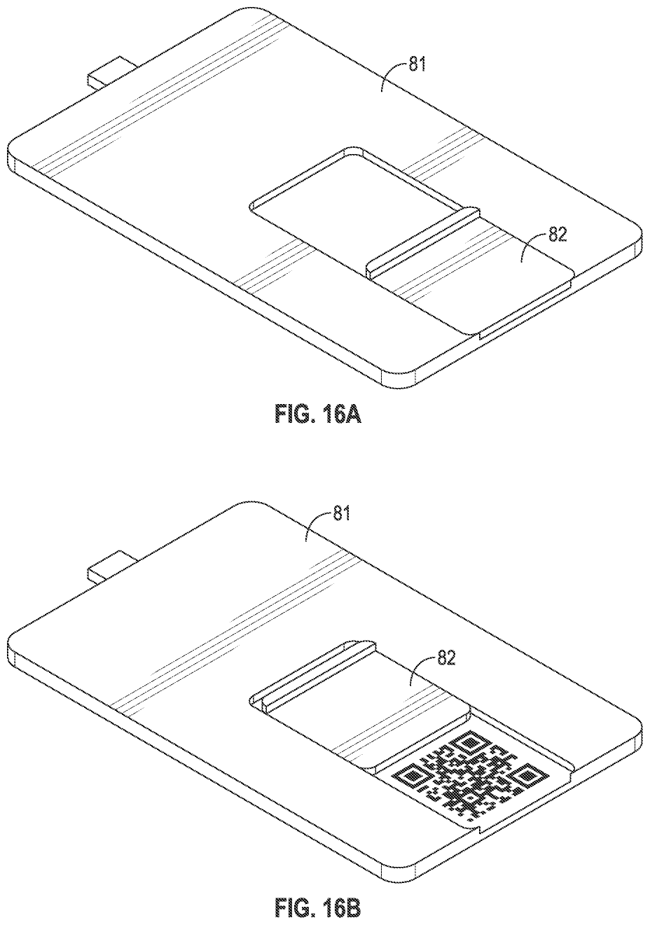

### Private Radio Transceiver Payment Card Embodiment Buyer Payment Configuration (See FIGS. 16-19)

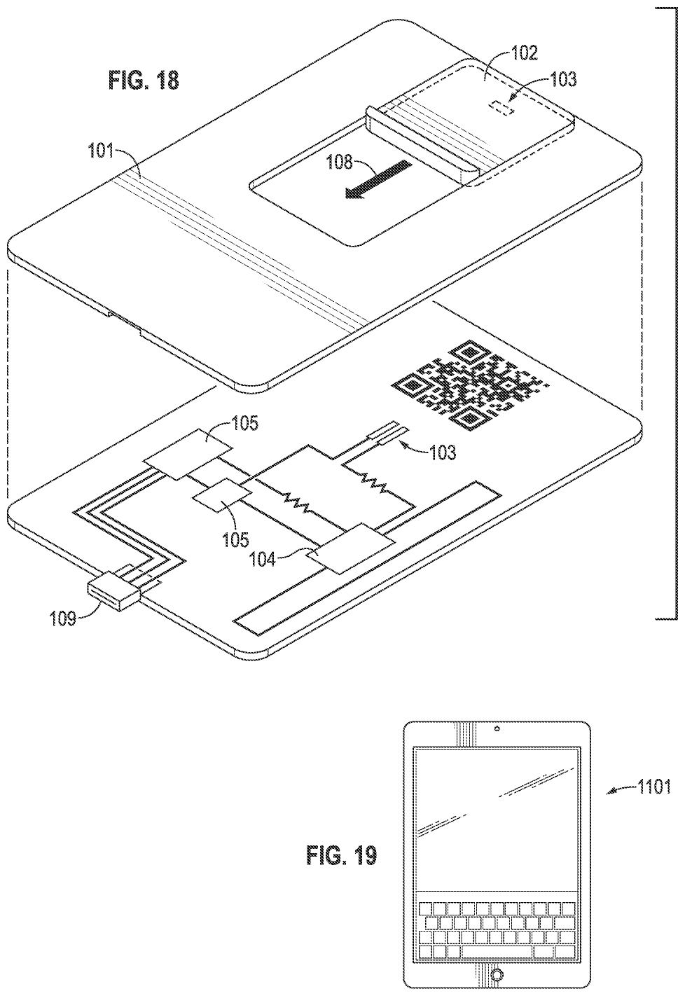

Card 81, preferably rectangular, displaying a scannable “key” code as depicted in FIGS. 16A, 16B and 18 with an opaque privacy slide 82 that prevents viewing the scannable code when closed (FIG. 16A) but allows viewing the scannable “key” code 83 when in the slid open position;

Opening the privacy slide actuates an electromechanical switch 103, 103′ (switch closes to complete circuit as illustrated) when the privacy slide is in the open position. See FIG. 18.

Closing of the switch energizes and activates radio transceiver 104 exampled by Bluetooth or WiFi.

And Simultaneously Activates an EPROM microchip or CPU 105 connected to RAM/Flash memory 105′ sufficient to run a computer software program.

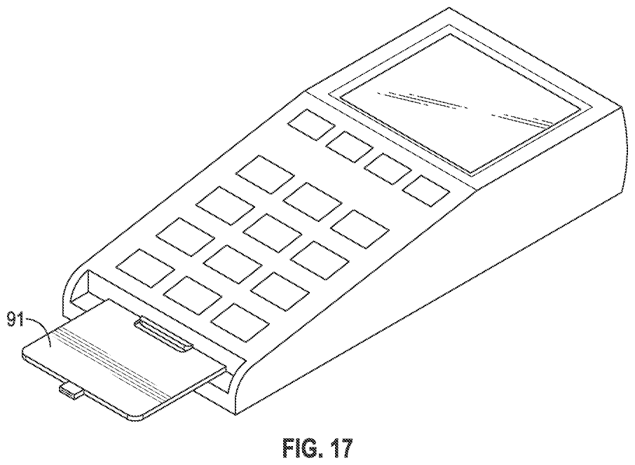

To connect with a payment terminal such as an ATM, card reader or functional equivalent 91 (see FIG. 17) and transmit card holder/user identity data;

And in the Preferred Embodiment connect to a Card Holder User's Laptop, Cell Phone, Tablet 1101 or functionally equivalent device to allow the card holder/user to input data such as PIN code, amount of purchase, tip preference, cash back and the like;

With the activation feature functionality of the radio transceiver being electronically enabled only when the opaque slide is in the open position (see arrow 108);

And in the Preferred Embodiment containing a USB, micro-USB or functionally equivalent electronic hardware port 109, (see FIG. 18) with the radio transceiver being deactivated with respect to a payment terminal device or device when used as a payment device by the BUYER except to allow uploading of software programming instructions, as well as, loading card holder/user data, including but not limited to multiple payment card identities such as VISA, DISCOVER, CHASE, Bank of America, or functional equivalent;

With the software only functioning when the payment terminal has read the scannable code while the privacy slide is open, decrypting the code, and providing the proper software unlock code to allow the mechanism to function.

NARRATIVE: User takes out the card and inserts it into the payment terminal slot. The privacy slide is opened, and the payment terminal reads the scannable code. The scannable code is decrypted, and the radio transceiver, flash drive, and EPROM are activated so that the payment terminal can read the payment card information.

Simultaneously, the transceiver communicates with the card holder user's mobile device to display information relevant to making an payment such as a list of available payment cards, a PIN display interface, a dialog box to allow input of the payment amount or a tip, or a notation of the purpose of the payment, without the need for the user to touch any part of the payment terminal such as a keypad, or public screen, with all input and output being handled through the user's mobile device.

The “card” contains a data port to allow hardware only communications for purposes of programming the card or when more secure communications without radio transmissions are desired. In this configuration, the payment card would be plugged into the Card Holder User's mobile device mini-USB port before being inserted into the payment processing machine, and all communications would be by “hardwire” without using radio frequencies.

The depiction presented should be considered the preferred embodiment in that at the most basic level the invention could be depicted as a card that displays a scannable code as the privacy slide is opened when the payment card is inserted into a payment terminal, with the scannable code being linked to the card holder user's identity data as depicted in FIG. 16B. When depicted in the most basic way, the embodied invention would rely on the software from the payment processor to link that card holder user's identity to the scannable code.

Obvious improvements, such as including a spring to close the privacy slide when the card is removed from the payment terminal slot have been omitted from the specification, in the interest of efficient expression of the embodiment, but should be considered an implicit part of the invention.

As an alternative embodiment to expressing the scannable code via a “card”, the card could be replaced by a wearable electronic device that employs a display such as depicted via a “smart-watch”, whereby the scannable code is electronically opaqued out unless a payment is about to be made. Due to limitations of electronic “hacking”, this embodiment would not be considered a preferred embodiment over the card, however.

### Seller Configuration

Seller Inserts the MicroUSB Dongle into the Seller's Laptop, Cell Phone, Tablet or functionally equivalent device to allow the Seller to receive an electronic payment from the BUYER.

The Insertion of the MicroUSB Dongle allows the device to be put into a mode receive payments e.g. a payment processing terminal. The Seller retracts the Opaque Privacy Slide to allow the BUYER's mobile device to view, scan and capture the image containing the image containing the SELLER′S scannable “key” code. This switches the payment RECEIVE function on while the Micro USB is inserted into the Seller's device.

For extra security a 2^{nd} contact switch might be used such that the USB dongle can slide into or out of the device for additional feature configurations.

In the Preferred Embodiment, the insertion of the MicroUSB dongle into the SELLER's device energizes and activates software to connect the SELLER'S device via radiofrequency such as Bluetooth or WiFi which is further connected to the SELLER'S financial institution or even directly to the BUYER'S device to allow a direct transfer of data payment string such as a hashed BITCOIN value.

Insertion simultaneously activates an EPROM microchip or CPU connected to RAM/Flash memory sufficient to run a computer software program to facilitate a wireless payment and to physically connect to the Seller's device which then employs software such that the Seller's device functions as a payment terminal whereby the BUYER reads the scannable code displayed by the SELLER while the privacy slide is open, decrypts the SELLER's scannable code, which provides the Seller Identity information to the BUYER as detailed in previous embodiments sufficient to facilitate a payment from Buyer to Seller.

In the Preferred Embodiment the invention when embodied as a payment terminal simultaneously connects, either directly or through the Seller's mobile device, to a BUYER's Laptop, Cell Phone, Tablet or functionally equivalent device to allow the BUYER to input data such as PIN code, amount of purchase, tip preference, cash back and the like without the need to physically touch any of the SELLER's physical hardware, such as PIN input keys, or the like.

With the payment terminal software preferably only functioning to receive a payment while the MicroUSB port dongle is inserted into the SELLER'S device, and while the privacy slide is retracted for the BUYER to scan the image containing the Seller's scannable code. As an enhancement, the scannable code displayed when the privacy slide is retracted may also be electronically displayed on the SELLER's mobile device in case the analog display beneath the privacy slide is damaged.

### New Invention

As noted above, patent application Ser. No. 13/509,041 provides for an electronic sales method wherein: “A buyer wishing to conduct a sales transaction with the seller is provided with a Smartphone and a decal, stamp, sticker or like embodying a barcode such as a two dimensional data matrix code.”

“The buyer captures seller data from the seller with the buyer's smartphone camera function and inputs into the smartphone the payment data using the buyer's smartphone display function. This information is then transmitted from the buyer's smartphone to a remote location for processing and approval of payment”

In application Ser. No. 14/079,402, incorporated into applications Ser. Nos.15/657,827, 16/285,650, and 16/866,132, the method described therein: “. . . employs a seller bar code encoding information electronically linkable to a seller's account, the seller's account belonging to an intended recipient of the electronic payment. A smart-phone with a camera function is employed by a buyer for capturing an image of the seller bar code. A wireless communication system is employed for transmitting data, including data representative of the seller bar code image, from the camera to a remote payment center. Computer applications are present on the smart-phone and at the remote payment center to enable data transmission over the wireless communication system and to authorize the payment center to transfer funds from a buyer's account, typically belonging to the smart-phone owner, to the seller's account. The method is carried out by providing an image of the bar code at a point of sale for goods or services, capturing or scanning an image of the bar code with the camera function of the smart phone, processing the image with the smart-phone application to form a wirelessly transmittable data file, wirelessly transmitting the data file from the smart-phone to the payment center, wirelessly transmitting a data file representative of a payment amount from the smart-phone to the data center, together or separately with the image data, electronically debiting the buyer's account by the payment amount, electronically crediting the seller's account by the payment amount, and transmitting data representative of the crediting of the seller's account to at least the seller.

Application Ser. No. 13/509041 depicts in detail using a scannable code displayed from a sticker, stamp or decal as method to identify the buyer; whereas, application Ser. No. 14/079402 and its progeny depicts displaying a merchant's scannable code from a merchant seller's point of sale terminal, and provides highly detailed descriptions of the processes to complete a sale utilizing scanning a seller merchant's barcode.

In combination, the prior applications noted above herein provide for a comprehensive clear specification wherein a merchant seller displays a scannable code from a sticker, stamp or decal as a method to identify the seller to consummate an electronic sale.

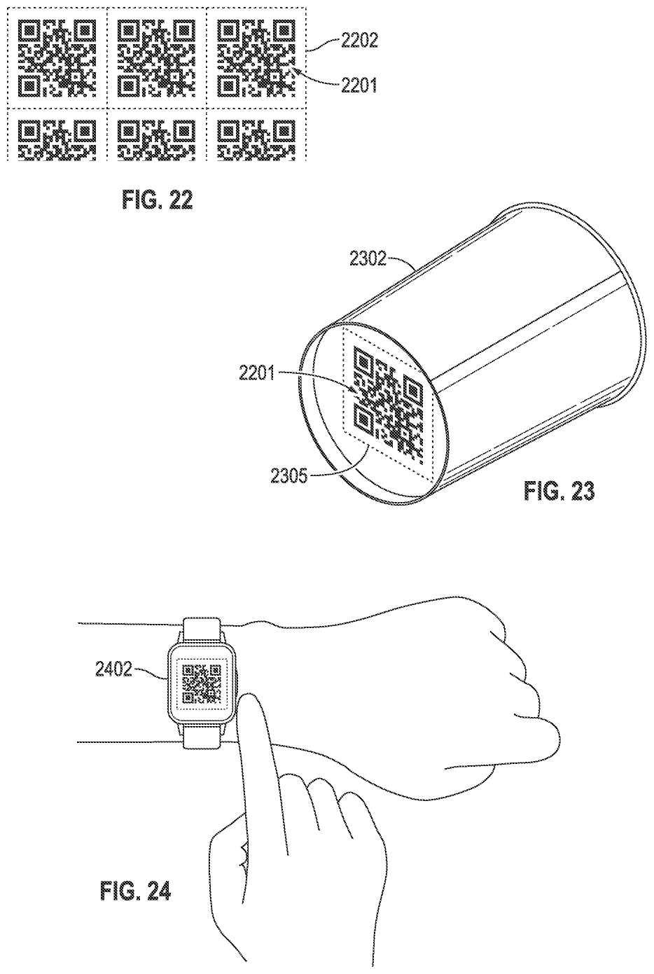

### Present Invention (FIGS. 22-24)

### Embodiment 1

Instead of displaying the seller merchant bar code from a point of sale terminal, the scannable code is displayed from a sticker, stamp or decal, and then scanned by the buyer to consummate an electronic sale transaction. Preferably, the code is displayed on the goods. Preferably, the scannable code is a merchant controlled image such as a logo or other copyrightable photograph, for example, as depicted in FIG. 8, which has been altered in such a way as to make it scannable by a buyer's smartphone. The merchant seller decals 2201 can be printed on sheets 2202 as shown on FIG. 22 and then placed onto a merchant controlled personal object such as a coffee cup 2302, menu, countertop, or vending machine to be scanned by the buyer. FIG. 23 shows the decal sticker attached to a coffee cup.

### Embodiment 2

The merchant's scannable code is printed directly on to a merchant controlled object such as a coffee cup similar to that depicted in FIG. 23 (without the dotted lines 2305), and then scanned by the buyer to consummate an electronic sale transaction. Preferably, the scannable code is a merchant controlled image such as a logo or other copyrightable photograph as depicted in FIG. 8 which has been altered in such a way as to make it scannable by a buyer's smartphone. Typically, a sticker will be more cost effective than a direct printing onto an object and would be considered the preferred practice.

### Embodiment 3

The merchant's scannable code is transmitted from a merchant's point of sale device and displayed on a personal object of the buyer such as a buyers “smart-watch” 2402 as depicted in FIG. 24 (or functionally equivalent device controlled by the buyer) which is then scanned by the buyer's smartphone. The seller's scannable code is then scanned by the buyer to consummate an electronic sale transaction. Preferably, the scannable code is a merchant controlled image such as a logo or other copyrightable photograph as depicted in FIG. 8 which has been altered in such a way as to make it scannable by a buyer's smartphone.

### NEW EMBODIMENT—Coin Counting Machine Employing Scannable Codes

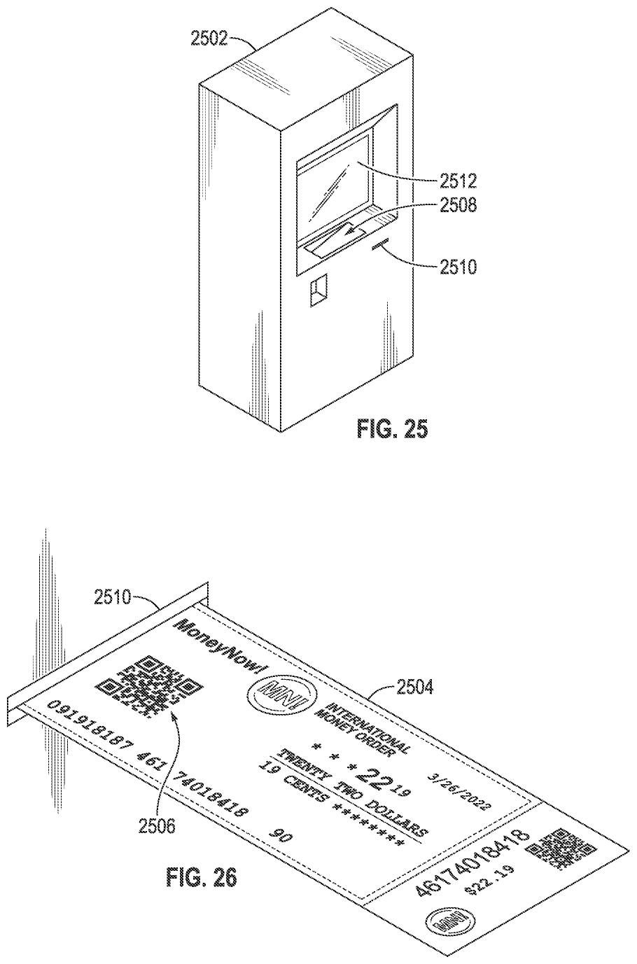

In an additional embodiment, a coin counting machine 2502 generates a money order 2504, which can be negotiated by the Payee using a scannable code 2506 or codes which contain the Payee information, routing number, and account number of the Merchant Bank Account where the money order will be drawn or otherwise negotiated. As depicted in FIG. 25, a coin counting machine is depicted where the User/Payor deposits coins into a chute 2508 of machine 2502 that totals the amount of coins deposited and print a money order or other ticket out via slot 2510. While an embodiment with a coin counting machine is depicted, the steps presented would be the functionally equivalent for depositing and counting paper currency in an ATM.

As the coins are being counted, the Payor enters certain information on a digital screen of the Payor's mobile device which could be provided through a Bluetooth link, Wi-Fi or equivalent to a smartphone or tablet connected via radio signal to the coin counting machine. A keyboard and touch display screen 2512 could also be provided that is electromechanically connected to the coin counting machine in lieu of using the Payor's mobile device. The information entered by the Payor includes the amount of the money order to be issued and the name of the payee that the Payor wishes to send the money order to, up to the amount that is available per the coin count. Preferably, the fees to issue the money order are shown as deducted, with the remaining balance to be available for issuance of a money order. Preferably, the Payor is able to select the currency type so that the money order can be issued in any local currency desired anywhere in the globe.

Optionally, the Payor may enter their email address and the address of the Payee, the phone number Payor and the phone number of the Payee, the address of the Payor and the physical address of the Payee where the Payor wishes to have the company issuing the money order provide mailing associated with a “bill pay” feature.

Where the Payor includes email addresses, details of the payment and tracking if posted by mail can be sent by email to the Payor and/or Payee.

Where the Payor includes phone numbers, details of the payment, details of the payment and tracking if posted by mail can be sent by text to the Payor and/or Payee.

Optionally, the coin counting machine is linked to a printer with the capability of securely printing a money order that can be collected by the Payor which contains the Payee information, but is then delivered by hand or posted by the Payor to the Payee.

As depicted in FIG. 26, the money order contains a scannable code which could be in the form of a scannable logo or image, which is scanned by the Payee by the Payee's smartphone, tablet or other mobile device employing a scanner. Software in the Payee's scanning device is linked to the Payee's bank and bank account, which contains the Payee's routing number and account number to effect a deposit.

The scannable code could be either printed directly on the money order (preferable) or printed onto a sticker that is the placed on the money order.

Preferably, mailing of the money order employs the best practices as depicted in patent application U.S. Ser. No. 17/704,498. Patent application Ser. No. 17/704,498 is incorporated by reference herein in total as if copied verbatim.

Preferably, only an intranet connection (between the coin counting machine and the Payor's mobile device) is used when entering sensitive information, such as email addresses, passwords, phone number, and even Payee information, so that even brute force access is not possible through an internet connection while such information is being entered. Encryption best practice as also preferably employed.

Preferably, the Payee's information is not displayed in human readable form on the money order so that visual eavesdropping in not possible by a casual observer.

In a preferred embodiment, the encoded information on the money order and receipt can include at least two, preferably all, of the following:
Issuer, e.g.—Money Now!
Payee,
Descriptor-e.g.—International Money Order
Amount—Show on M.O. And receipt
Issuer Routing Number
Issuer Acct Number
Unique Serial Number on Receipt for tracking.
Amount on Receipt
Issue date on MO and receipt

It is noted that other embodiments which are functionally equivalent to those presented here may not be specifically embodied, but should be consider included herein.

1. A method for conducting an electronic payment making use of a sticker, stamp or decal containing a seller bar code encoding information to enable electronic payment to a merchant seller's account, said merchant seller's account belonging to an intended recipient of the electronic payment,
a buyer's smart-phone with a camera function for scanning or capturing an image of the seller's bar code and a keypad for entering a payment amount,
a remote electronic payment center for maintaining a buyer's account and making electronic payments from the buyer's account,
a wireless communication system for transmitting data, including data representative of the seller's bar code image, and the payment amount,
to the remote electronic payment center, and applications present on the smart-phone and at the remote payment center to enable data transmission of the data over the wireless communication system from the buyer's smart-phone to the remote electronic payment center using a send command and to authorize the remote electronic payment center to electronically transfer funds from a buyer's account associated with the buyer's smart-phone to the seller's account,
said method comprising
providing an image of the seller bar code at a point of sale for goods or services,
scanning or capturing an image of the seller bar code with the camera function of the smart phone,
processing the image with the smart-phone application to form a wirelessly transmittable seller data file,
wirelessly transmitting the seller data file from the smart-phone to the electronic payment center,
wirelessly transmitting a payment data file representative of a payment amount from the smart-phone to the electronic payment center,
electronically debiting the buyer's account by the payment amount,
electronically crediting the seller's account by the payment amount, and
transmitting data representative of the crediting of the seller's account to the seller.

2. An object offered for sale in a vendor's facility, said object having a closely physically associated two-dimensional scannable code, said two-dimensional scannable code encrypting, in addition to information about the object, sufficient vendor information to enable payment to the vendor for the object using a smartphone.

3. An object as in claim 2 wherein the two-dimensional scannable code is a QR code printed on a sticker attached to the object.

4. A method for converting coinage into a negotiable document, said method comprising
electro-mechanically counting the coinage in an ATM having such capability and producing a tally,
and printing a negotiable document in the amount of the tally less a fee for use of the ATM,
wherein the negotiable document bears a printed two-dimensional scannable code encoding at least two of the following:
Issuer,
Payee,
Descriptor,
Amount,
Issuer Routing Number,
Issuer Acct Number,
Serial Number, and
Issue date.

5. A method as in claim 4 wherein the two-dimensional scannable code is a QR code.

6. A method as in claim 5 wherein the negotiable document is a money order.

7. A method as in claim 5 wherein the ATM is a coin counting kiosk.

8. A the negotiable document bearing a printed two-dimensional scannable code encoding at least two of the following:
Issuer,
Payee,
Descriptor,
Amount,
Issuer Routing Number,
Issuer Acct Number,
Serial Number, and
Issue date.

9. A negotiable document as in claim 8 wherein the two-dimensional scannable code is a QR code.

10. A negotiable document as in claim 9 which is a money order.

11. A money order as in claim 10 having an attached receipt also bearing the QR code.
